(19) United States
(12) Patent Application Publication
(10) Pub. No.: US 2011/0036163 A1
(43) Pub. Date: Feb. 17, 2011

(54) Method for Filling a Pressurized Gas Tank

(75) Inventor: Jean-Yves Thonnelier, Voisins Le Bretonneux (FR)

Correspondence Address: American Air Liquide, Inc.;Intellectual Property Dept., 2700 Post Oak Boulevard, Suite 1800, Houston, TX, 77056, US

(73) Assignee: L'Air Liquide Societe Anonyme Pour L'Etude Et L'Exlotation Des Procedes Georges Claude, Paris, Cedex (FR)

(21) Appl. No.: 12/063,315

(22) PCT Filed: Jul. 20, 2006
(86) PCT No.: PCT/FR06/50735

§ 371 Date: Sep. 13, 2010

(51) Int. Cl. G01F 23/14

(52) U.S. Cl. 73/303

(57) ABSTRACT

The invention relates to a method for filling a pressurised gas tank, especially a pressurised tank for a protective airbag-type system, with a gas or a gaseous mixture. Said method comprises a first step wherein a determined first quantity of a gas or a gaseous mixture in the liquid state is introduced into the tank. The inventive method is characterised in that the first introduction step comprises an intermediate introduction step wherein an intermediate quantity of a gas or a gaseous mixture in the liquid state is introduced into the tank, the intermediate quantity being larger than the first quantity. The inventive method also comprises a step for removing part of the gas in the liquid state, in excess of the first quantity, from the tank, in such a way as to dose the first quantity of gas in the liquid state in the tank.

The present invention relates to a method for filling a pressurized gas reservoir.

The invention relates more particularly to a method for filling a pressurized gas reservoir, in particular a pressurized reservoir for a protection system of the airbag type, with a gas or a gas mixture, comprising a first step of introduction of a first fixed quantity of gas or gas mixture in the liquid state into the reservoir.

According to this filling method, one or more gases are introduced into the reservoir in the cryogenic liquid state. After the introduction of the gas in the liquid state followed possibly by the introduction of an additional gas in the gas state, the reservoir is then closed and heated (the heating can be carried out by an active heating or by stopping its cooling and allowing it to stand at ambient temperature). In this way, the gas or gas mixture is vaporized in the reservoir and thereby generates a high pressure, for example 500 bar, 700 bar or more.

Such a method is described in particular in document WO 2005/59431.

In such a method, it is very important to control the precise batching of the quantity of gas in the liquid state introduced into the reservoir. In fact, this batching conditions the operating characteristics of the filled reservoir and particularly the pressure of the gas it contains when it is at ambient temperature.

A known solution for carrying out this batching consists in accurately measuring the quantity of gas introduced into the reservoir, for example by pressure gauge or flow detection means. Another solution consists in accurately measuring the volume of liquid introduced by using a buffer tank between the liquid source and the reservoir to be filled. The buffer tank has volume characteristics that serve to control the volume of gas delivered to the reservoir to be filled.

However, these methods are relatively complex, costly and difficult to implement industrially on a large scale, particularly at high production rates.

Furthermore, in the case in which the reservoir is not closed immediately after the introduction of the gas in the liquid state and must undergo an additional operation (for example, the introduction of an additional gas or gas mixture), there is a risk that a part of the liquefied gas will evaporate and escape from the reservoir. These potential leaks may also occur when the reservoir is conveyed to a welding machine for hermetically sealing it. The dispersions thus created alter the characteristics of the final reservoir.

It is an object of the present invention to overcome all or part of the drawbacks of the prior art described above.

For this purpose, the method for filling a pressurized gas reservoir according to the invention, which also conforms to the generic definition given in the above introduction, is essentially characterized in that the first introduction step comprises a step of intermediate introduction of an intermediate quantity of gas or gas mixture in the liquid state in the reservoir, the intermediate quantity being higher than the first quantity, and a step of withdrawal of a part of the gas in the liquid state from the reservoir in excess of the first quantity, in order to batch the first quantity of gas in the liquid state in the reservoir.

Moreover, the invention may comprise one or more of the following features:
the reservoir is cooled before and/or during at least the intermediate introduction step,
the intermediate quantity corresponds substantially to the total filling of the reservoir,
the intermediate introduction step comprises an operation of flow of the gas or of the gas mixture in the liquid state from a source to the interior of the reservoir via an orifice of the reservoir,
the intermediate introduction step comprises a step of immersion of the reservoir in a bath consisting of the gas or the gas mixture in the liquid state intended for filling the reservoir, in order to permit the flow of the liquid from the bath to the interior of the reservoir,
the withdrawal step comprises an operation of determination of the liquid level in the reservoir corresponding to the fixed quantity,
the withdrawal step comprises an operation of suction of the gas in the liquid state inside the reservoir,
the gas in the liquid state introduced into the reservoir during the first introduction step comprises argon,
the method comprises a second step of introduction of an additional second fixed quantity of a gas or gas mixture in the liquid state into the reservoir,
the additional gas or gas mixture introduced in the gas state into the reservoir during the second introduction step comprises helium.

Other features and advantages will appear on a reading of the description below, provided with reference to the figures appended hereto in which:

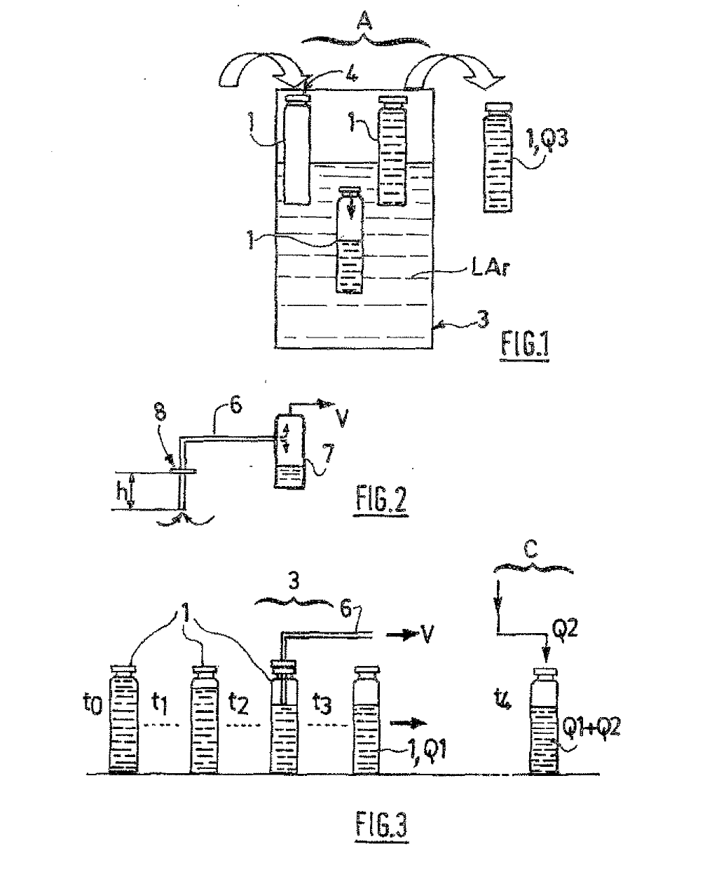

FIG. 1 shows a side and schematic view illustrating the structure and operation of an embodiment of an introduction step of the filling method according to the invention,

FIG. 2 shows a schematic view illustrating the structure and operation of an embodiment of a suction system suitable for use during a withdrawal step of the filling method according to the invention,

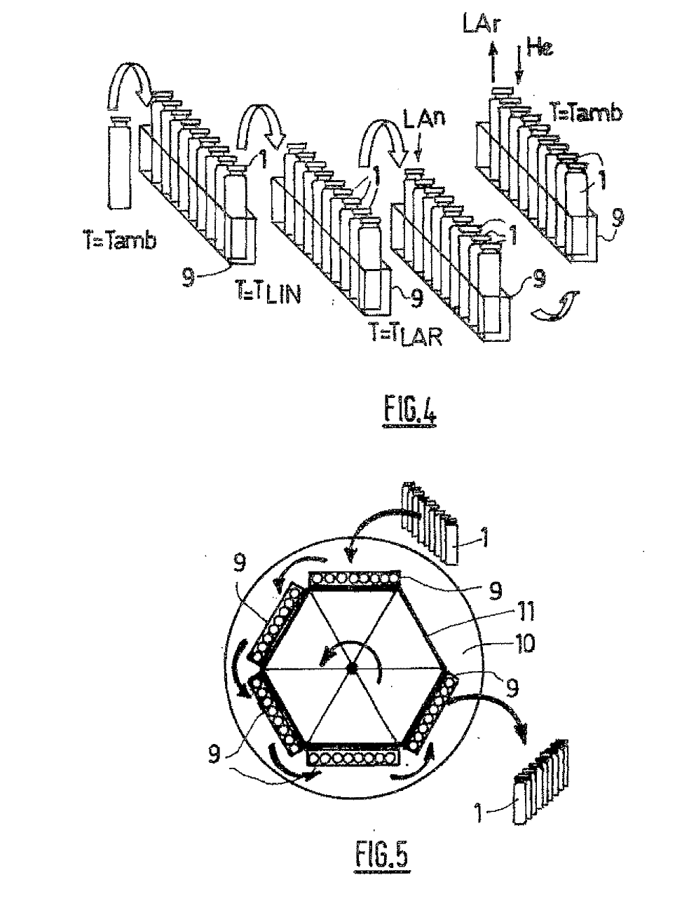

FIG. 3 shows a side and schematic view illustrating the structure and operation of an embodiment of a withdrawal step of the filling method according to the invention,

FIG. 4 shows a perspective and schematic view illustrating the structure and operation of an embodiment of the filling method according to the invention applied to a plurality of reservoirs,

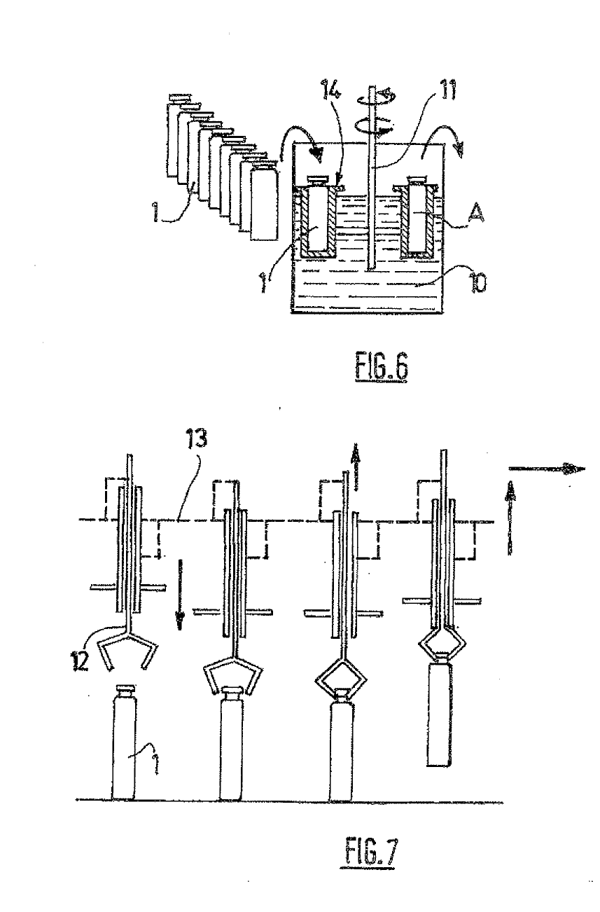

FIG. 5 schematically shows a plan view of the structure and operation of an embodiment of a reservoir cooling station according to the invention,

FIG. 6 shows a side view of the cooling station of FIG. 5,

FIG. 7 schematically shows a side view, the structure and operation of an embodiment of a reservoir handling station for putting into practice the method according to the invention.

An example of the filling of the reservoir 1 with an argon/helium gas mixture will now be described with reference to FIGS. 1 to 3. In this example, a first quantity Q1 of argon is first introduced in the liquid state, a second quantity Q2 of helium being introduced subsequently in the gas state.

To introduce a first fixed quantity Q1 of liquid argon into the reservoir 1, a first step A (FIG. 1) may consist in introducing into the reservoir 1 a quantity Q3 of liquid argon that is higher than the first quantity Q1. In a second step B (FIG. 3), the liquid argon of the reservoir 1 that is in excess over the first quantity Q1 is withdrawn from the reservoir 1.

The first step A may consist in immersing the reservoir 1, for example completely, in a bath 3 of liquefied cryogenic argon (LAr, temperature of −186° C. or lower). This means that the empty reservoir 1 is open at the level of at least one orifice 4 and is immersed in the bath 3 of liquid argon so that the argon penetrates into its internal volume. Preferably, the reservoir 1 may be completely filled with liquid argon.

Advantageously, the reservoir 1 may be precooled before being immersed into the bath 3 of liquid argon. For example, and as described in greater detail below with reference to FIGS. 4 to 6, the reservoir 1 may be precooled to a temperature lower than the temperature of the argon bath 3. For example, the reservoir 1 is partially immersed in a bath 5 of liquid nitrogen at a temperature of −196° C. or lower. The immersion is preferably arranged to prevent the entry of liquid nitrogen into the reservoirs 1 (particularly by controlling the immersion level and/or with means for protection against nitrogen spattering). Protection means 14 such as deflectors or screens may in particular be provided on the frame 11 that maintains the reservoirs 1 in the bath 10. The protection means 14 may form a screen between the surface of the bath 10 and the inlet of the reservoirs 1 (FIG. 6).

As a variant or in combination, it is possible for the bath 3 of liquid argon to be maintained at a temperature lower than the boiling point of liquid argon (lower than −186° C.). For example, the bath 3 of liquid argon may be cooled by a second colder external bath (liquid nitrogen for example).

After its filling in the argon bath 3 (quantity Q3), the reservoir 1 is withdrawn from the argon bath 3 and may be the subject of other handlings/operations or may be allowed to stand at ambient temperature (or at least at warmer temperatures than those of the bath 3). Thus, between the times to just after the withdrawal from the bath 3 and a later time t1, a quantity of liquid argon may evaporate from the internal volume of the reservoir 1 (FIG. 3). This evaporation is not detrimental to the final batching of the gases in the reservoir 1. In fact, since the reservoir 1 contains a quantity Q3 of liquefied argon that is higher than the first and necessary quantity Q1, the reservoir 1 thus has greater autonomy and higher thermal inertia with respect to the excessive risks of evaporation of argon outside its volume. In this way, the cold reservoir 1 containing liquid argon can be used with greater flexibility in a more extended process.

After the handlings and/or a waiting period (between to and t1, FIG. 3) and just before the time t4 of the introduction of helium into the reservoir 1, the liquid argon in excess of the first quantity Q1 is withdrawn from the reservoir 1 (time t2, FIG. 3). In fact, the liquid argon in excess of the first quantity Q1 is preferably withdrawn from the reservoir 1 just before the closure of the reservoir 1. In this way, the closed reservoir 1 contains precisely the desired first quantity Q1 of argon.

The withdrawal of excess liquid argon can be carried out, for example, by sucking liquid argon from the reservoir 1. For example, and as shown in FIGS. 2 and 3, a suction line 6 may be provided to withdraw the excess liquid argon. The suction line 6 may comprise a first end connected to negative-pressure or vacuum means V, and a second end for immersion into the reservoir 1 via its orifice. Between these two ends, the suction line 6 may comprise a vessel intended to collect the argon sucked from the reservoir 1 (for its recycling, for example). To suck precisely the excess quantity of liquid argon in the reservoir I and no more, the second end of the suction line 6 may comprise suction limiting means 8 that serve to limit the liquid level below which the liquid is no longer sucked from the reservoir 1. For example, the suction limitation means 8 cooperate in thrust with the end of the reservoir 1 (at the level of the orifice, for example). These suction limitation means 8 are preferably adjustable for height h to permit the accurate adjustment of the quantity of liquid to be preserved in the reservoir 1. This adjustment serves in particular to adapt the suction to various geometries/volumes of reservoirs 1 and to various quantities of liquid Q1.

After suction (time t3, FIG. 3), the reservoir 1 contains precisely the desired first quantity Q1 of argon. The reservoir 1 may be conveyed to a compressed gas filling station. Thus, during a subsequent step (time t4, FIG. 3), a second quantity Q2 of helium gas may be introduced into the reservoir 1. The helium gas is introduced, for example, at ambient temperature at a pressure between 5 and 50 bar, and preferably at about 10 to 20 bar. The reservoir 1 is then rapidly closed. Preferably, the orifice of the reservoir 1 is closed at the level of the helium filling station. The closed reservoir 1 may be heated actively or allowed to stand at ambient temperature.

Preferably, the quantities Q1 of liquid argon and helium Q2 filled in the reservoir 1 are selected in order to form a gas mixture in the reservoir 1 at ambient temperature (for example 15° C.) with the following proportions by volume: argon 97% and helium 3%.

Obviously, the invention may apply to any other type of gas or gas mixture (argon, helium, CO2, N2, N₂O, H₂, O₂ . . . ) with all possible relative proportions.

To carry out the filling of reservoirs on an industrial scale, all or part of the steps described above are preferably carried out simultaneously and/or in succession on a plurality of reservoirs 1. For example, a set of eight to twelve reservoirs 1 is placed on a common support 9 (cf. FIGS. 4 to 6). In this way, the number of handlings and the duration of the filling method according to the invention can be reduced.

By referring now to FIG. 4, four steps of the method are symbolized for a set of nine reservoirs 1 mounted in the same support 9. The four steps are shown chronologically from left to right in FIG. 4. In the first step, the reservoirs 1 are placed in a support 9 at ambient temperature (T=Tamb). The support 9 containing the reservoirs 1 is then immersed in the precooling bath (temperature T=TLIN=temperature of the liquid nitrogen bath). The support 9 containing the reservoirs 1 is then immersed in the liquid argon bath (temperature T=TLAR) and the reservoirs 1 are filled therein with liquid argon. Finally, in the fourth step, the reservoirs 1 are withdrawn from the liquid argon bath (T=ambient temperature Tamb), are emptied of a part of their liquid argon and then filled with helium gas and then closed.

FIGS. 5 and 6 illustrate an embodiment of the step of precooling of the reservoirs 1. It is in fact possible to provide a simultaneous precooling of a plurality of reservoirs 1 and in particular, a simultaneous precooling of a plurality of supports 9 of reservoirs 1. As shown, the precooling bath 10 (liquid nitrogen or other) may comprise an immersed and mobile frame 11 suitable for accommodating several supports 9 of reservoir 1 at the same time. If the frame 11 rotates and can accommodate six supports 9, it is possible to immerse/withdraw the frames from the bath sequentially and successively (loading/unloading at each rotation of 60 degrees).

In such a non-limiting configuration, the reservoirs 1 may thus reside in the bath 10 for a duration five times longer than the duration of a loading/unloading of a support 9.

According to an advantageous feature, the means for handling the reservoirs 1 are arranged so that their components which are sensitive to low temperatures (motors, lubricated hinges, moving mechanical parts in friction, electrical parts . . . ) are relatively distant from the reservoirs 1 and from the cryogenic baths 3, 10. For example, the handling and/or treatment means for the reservoirs 1 are arranged at two distance levels relative to the low temperature portions (cold reservoirs, cryogenic baths). Thus, the handling/treatment components are arranged close to and/or in contact with the cold portions. These handling/treatment components, such as manipulator arms 12, are preferably made from stainless steel and/or low-thermal-conductivity materials (FIG. 7) unaffected by the low cryogenic temperatures.

The components 13 sensitive to low temperatures are arranged at a greater distance from the cold elements, for example by about 1.5 to 2 m. In FIG. 7, these elements 13 sensitive to low temperatures are located above the parts 12 that are unaffected by the low temperatures and are symbolized by broken lines.

In this way, only the parts capable of withstanding cryogenic temperatures are exposed to these low temperatures. The parts 13 sensitive to low temperatures are beyond the limits of the risks of direct or indirect cooling caused by the cold portions.

The handling/treatment components 12 are liable to accumulate frost or ice in contact with the low temperature portions. Advantageously, defrosting zones may be provided between the immersion stations and the cryogenic baths. These defrosting zones (not shown) may, for example, comprise means for heating the handling/treatment components 12, for example by blowing.

It is therefore easy to conceive that the method according to the invention, while having a simple structure, permits an effective filling of reservoirs suitable for large scale production, particularly at high production rates.

The invention applies particularly advantageously to the filling of pressurized gas reservoirs or cylinders for airbags. Obviously, the method according to the invention may apply to any other equivalent application.

Furthermore, the invention is not limited to the embodiment described. Thus, the reservoir precooling step may be carried out by any other equivalent means (jet or flow of cryogenic liquid against the outer walls of the reservoir, for example).

Similarly, it is possible to omit this precooling step. In this case, the cooling of the reservoir 1 is carried out exclusively by the gas in the liquid state of the bath 3 (external and internal cooling by liquid argon).

Furthermore, the first quantity Q1 of gas introduced may comprise gas in the solid state (liquid/solid mixture). Similarly, the second quantity Q2 of gas in the gas state may be cooled prior to its introduction into the reservoir 1. As a variant, this second quantity Q2 of gas (optional) may consist of or comprise gas in the liquid and/or solid state. Moreover, the step A of intermediate introduction of a quantity Q3 of gas in the liquid state into the reservoir 1 may be carried out by any other equivalent known means. For example, it is possible to transfer the liquid argon to the reservoir 1 via a line supplied by a liquid argon source.

1-10. (canceled)

11. A method for filling a pressurized gas reservoir, in particular a pressurized reservoir for a protection system of the airbag type, with a gas or a gas mixture, comprising a first step of introduction of a first fixed quantity of gas or gas mixture in the liquid state into the reservoir, characterized in that the first introduction step comprises:
a step of intermediate introduction of an intermediate quantity of gas or gas mixture in the liquid state in the reservoir, the intermediate quantity being higher than the first quantity, and
a step of withdrawal of a part of the gas in the liquid state from the reservoir in excess of the first quantity, in order to batch the first quantity of gas in the liquid state in the reservoir.

12. The method according to claim 11, characterized in that the reservoir is cooled before and/or during at least the intermediate introduction step.

13. The method according to claim 11, characterized in that the intermediate quantity corresponds substantially to the total filling of the reservoir.

14. The method according to claim 11, characterized in that the intermediate introduction step comprises an operation of flow of the gas or of the gas mixture in the liquid state from a source to the interior of the reservoir via an orifice of the reservoir.

15. The method according to claim 11, characterized in that the intermediate introduction step comprises a step of immersion of the reservoir in a bath consisting of the gas or the gas mixture in the liquid state intended for filling the reservoir, in order to permit the flow of the liquid from the bath to the interior of the reservoir.

16. The method according to claim 11, characterized in that the withdrawal step comprises an operation of determination of the liquid level in the reservoir corresponding to the fixed quantity.

17. The method according to claim 11, characterized in that the withdrawal step comprises an operation of suction of the gas in the liquid state inside the reservoir.

18. The method according to claim 11, characterized in that the gas in the liquid state introduced into the reservoir during the first introduction step comprises argon.

19. The method according to claim 11, characterized in that it comprises a second step of introduction of an additional second fixed quantity of a gas or gas mixture in the liquid state into the reservoir.

20. The method according to claim 19, characterized in that the additional gas or gas mixture introduced in the gas state into the reservoir during the second introduction step comprises helium.
